(19) United States
(12) Patent Application Publication
(10) Pub. No.: US 2007/0143331 A1
(43) Pub. Date: Jun. 21, 2007

(54) Apparatus, system, and method for generating an IMS hierarchical database description capable of storing XML documents valid to a given XML schema

(76) Inventors: Christopher M. Holtz, San Jose, CA (US); Holger Seubert, Leinfelden-Echterdingen (DE)

Correspondence Address: Kunzler & McKenzie, 8 EAST BROADWAY, SUITE 600, SALT LAKE CITY, UT, 84111, US

(21) Appl. No.: 11/304,272

(22) Filed: Dec. 14, 2005

(51) Int. Cl. G06F 7/00

(52) U.S. Cl. 707/102

(57) ABSTRACT

An apparatus, system, and method are disclosed for automatically generating an Information Management System (IMS) hierarchical database description from an arbitrary Extensible Markup Language (XML) schema. The apparatus, system, and method may include the steps of: parsing an XML schema including a single root element; generating an XML schema tree that corresponds to the XML schema; generating an IMS segment tree such that each XML schema node is represented by a corresponding IMS segment node; reducing the number of IMS segment nodes from the IMS segment tree based on reduction rules, such that the IMS segment tree corresponds to IMS hierarchical database constraints; and generating IMS database description corresponding to the reduced IMS segment tree.

### BACKGROUND OF THE INVENTION

1. Field of the Invention

This invention relates to database storage systems and more particularly relates to storing Extensible Markup Language (XML) documents within a hierarchical Information Management (IMS) database.

2. Description of the Related Art

The overall use of XML documents is growing substantially as the software industry embraces XML as a universal exchange format. This growth in use has resulted in a need to more efficiently organize, index, and query stored XML documents. Typically, the XML documents are stored in databases designed to manage large amounts of storage data. Many conventional databases have defined ways for handling XML documents in their existing relational databases but have failed to utilize the hierarchical structure of XML documents when storing them in a hierarchical database. Instead, the raw XML document is stored. Consequently, the elements of the XML document are not easily indexed or searched.

IMS (Information Management System), from IBM of Armonk, N.Y., is the world's foremost hierarchical database. It is a collection of programs for storing, organizing, modifying, and extracting data from a database. Because IMS is organized hierarchically, IMS usually contains more than one level of data, with each lower level depending from a higher level. IMS organizes storage data in different hierarchical structures to optimize storage and retrieval, and ensure integrity and recovery. Because XML documents are also structured hierarchically, IMS is a much more natural fit than relational databases for storing XML documents.

However, IMS does have its own difficulties in handling XML documents. Currently, IMS only stores very strongly structured hierarchical data as defined by a particular database description (DBD). Each database, as designed, places specific structural and physical constraints on the hierarchical data the database may contain. Consequently, there are structural and physical constraints on the type of XML documents that can be represented by the contained hierarchical data. These constraints on the structure and content of the represented XML documents can be described using an XML schema definition. In order to properly store XML documents in a hierarchical database, there must be an agreement between the particular IMS DBD used to describe the allowed data in the database, and the corresponding XML schema used to describe the XML documents to be represented in the database.

The simplest way to store an XML document into an IMS database so that the XML document can be faithfully reconstructed is to store the complete text as a flat file in an IMS root segment. Because XML documents can be any length, and IMS segments have a finite maximum length, any text longer than the defined root segment can be broken up and stored into any number of overflow child segments. Then the XML document can be faithfully reconstructed by retrieving the complete IMS record and stitching the segment data back together. Although this method offers faithful storage and retrieval of XML documents, it does not integrate the hierarchical model of an XML document with the hierarchical structure of an IMS database. Therefore, users cannot take full advantage of the searching capabilities of IMS nor make any attempt at matching XML storage to the way IMS databases store hierarchical data today.

By mapping an XML schema structure to an IMS database structure and generating a corresponding DBD, users can more effectively take advantage of the benefits of hierarchical storage. However, this may require some reduction of the IMS database structure in order to meet IMS storage constraints.

From the foregoing discussion, it should be apparent that a need exists for an apparatus, system, and method to generate a hierarchical database description capable of storing XML documents valid to a given XML schema. Beneficially, such an apparatus, system, and method would allow for the more efficient organizing, indexing, and querying of XML documents.

### SUMMARY OF THE INVENTION

The present invention has been developed in response to the present state of the art, and in particular, in response to the problems and needs in the art that have not yet been fully solved by currently available hierarchical databases. Accordingly, the present invention has been developed to provide an apparatus, system, and method for automatically generating an Information Management System (IMS) hierarchical database description (DBD) from an arbitrary Extensible Markup Language (XML) schema that overcome many or all of the above-discussed shortcomings in the art.

The apparatus is provided with a logic unit containing a plurality of modules configured to functionally execute the necessary steps for generating an IMS DBD from an arbitrary XML schema. These modules in the described embodiments include a parsing module, an XML schema tree module, an IMS segment tree module, a reduction module, and a database description module.

The parsing module parses an XML schema comprising a single root element. Parsed data is made up entirely of text, defined as a sequence of characters. In order to accurately round trip an XML document through an IMS database, enough information must be captured in order to completely reconstruct the original full text contained inside any given stored XML document.

The XML schema tree module generates an XML schema tree that corresponds to an XML schema. An XML schema tree is a hierarchical representation of the XML schema structure. The schema tree module may also store the XML schema such that metadata within the XML schema that is redundant for each XML document valid with respect to the XML schema is accessible to an IMS hierarchical database system to recreate the XML document using the stored XML schema and the IMS database that corresponds to the IMS database description. The IMS segment tree module generates an IMS segment tree that corresponds in structure and order to the XML schema tree such that each XML schema node is represented by a corresponding IMS segment node. Character data from an XML document may be represented by data stored within the fields of the IMS segments that comprise the IMS segment tree. Preferably, the XML document comprises a validated XML document with respect to the XML schema. By aligning the document order of the XML schema with the IMS database hierarchic order, the document order is preserved such that an XML document generated from the IMS database description retains the same XML document order. Typically, the IMS segment tree is generated by mapping XML schema particles to IMS segment definitions.

The reduction module reduces the number of IMS segment nodes from the IMS segment tree based on reduction rules, such that the IMS segment tree corresponds to IMS hierarchical database constraints. The reduction module may eliminate IMS segment nodes that correspond to XML schema tree nodes having a minOccurs value and a max Occurs value equal to zero. IMS segment leaf nodes that correspond to XML schema nodes defined by the XML schema to have a predetermined number of occurrences and no data fields may also be eliminated. IMS segments having corresponding XML schema nodes with fixed value simple data types may also be eliminated. Additionally, the reduction module may merge a child IMS segment with a parent IMS segment node in response to the child IMS segment node having a one-to-one relationship with the parent IMS segment node. IMS segment leaf nodes may also be merged into fields of a parent IMS segment node such that the child IMS segment order is preserved by the sequential ordering of the corresponding fields in the parent IMS segment. In one embodiment, the reduction module may reduce the IMS segment tree such that the IMS database description comprises less than 16 levels and less than 256 segments. The reduction module is able to reduce the number of IMS segment nodes because the IMS database also stores the XML schema. Certain structural information and data values can be recreated when accessing the XML document by referencing the stored XML schema.

The database description module generates an IMS database description corresponding to the reduced IMS segment tree. An IMS database description defines the physical implementation and structure of an IMS database. The IMS database description can then be used to implement a database capable of faithfully storing and retrieving XML documents valid to a particular XML schema in a corresponding IMS database.

A system of the present invention is also presented to automatically generate an IMS hierarchical database description from an arbitrary XML schema. The system, in one embodiment, may include one or more processors, a memory, Input/Output (I/O) devices configured to interact with a user, an IMS database and an IMS database description utility substantially comprising the modules of the apparatus as described above.

A method of the present invention is also presented for automatically generating an IMS hierarchical database description from an arbitrary XML schema. The method in the disclosed embodiments substantially includes the steps necessary to carry out the functions presented above with respect to the operation of the described apparatus and system. In one embodiment, the method includes accessing an XML schema. The method may also include executing an IMS database description utility substantially comprising a parsing module, an XML schema tree module, an IMS segment tree module, a reduction module, and a database description module as described in the apparatus and system above.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for automatically generating an Information Management System (IMS) hierarchical database description from an arbitrary Extensible Markup Language (XML) schema in accordance with the present invention;

FIG. 2 is a schematic block diagram illustrating one embodiment of a database description (DBD) utility in accordance with the present invention;

FIG. 3 is a schematic block diagram illustrating one embodiment of an XML schema and its corresponding XML schema tree;

FIG. 4 is a schematic block diagram illustrating one embodiment of an XML schema tree and its corresponding IMS segment tree;

FIG. 5 is a schematic block diagram illustrating one embodiment of the reduction of an IMS segment tree;

FIG. 6 is a schematic block diagram illustrating embodiments of four reduction rules for merging child IMS segments with parent IMS segments; and

FIG. 7 is a schematic flow chart diagram illustrating one embodiment of a method for automatically generating an IMS hierarchical database description from an arbitrary XML schema in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

The term “programmed method”, as used herein, is defined to mean one or more process steps that are presently performed; or, alternatively, one or more process steps that are enabled to be performed at a future point in time. This enablement for future process step performance may be accomplished in a variety of ways. For example, a system may be programmed by hardware, software, firmware, or a combination thereof to perform process steps; or, alternatively, a computer-readable medium may embody computer readable instructions that perform process steps when executed by a computer.

The term “programmed method” anticipates four alternative forms. First, a programmed method comprises presently performed process steps. Second, a programmed method comprises a computer-readable medium embodying computer instructions, which when executed by a computer, perform one or more process steps. Third, a programmed method comprises an apparatus having hardware and/or software modules configured to perform the process steps. Finally, a programmed method comprises a computer system that has been programmed by software, hardware, firmware, or any combination thereof, to perform one or more process steps.

It is to be understood that the term “programmed method” is not to be construed as simultaneously having more than one alternative form, but rather is to be construed in the truest sense of an alternative form wherein, at any given point in time, only one of the plurality of alternative forms is present. Furthermore, the term “programmed method” is not intended to require that an alternative form must exclude elements of other alternative forms with respect to the detection of a programmed method in an accused device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

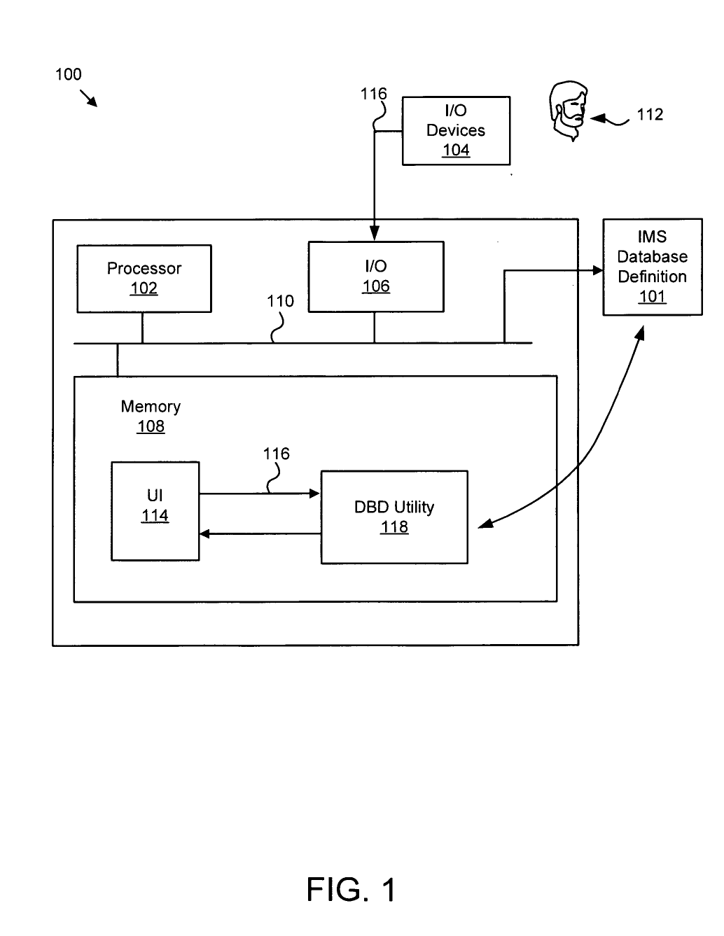

FIG. 1 depicts a system 100 for automatically generating an Information Management System (IMS) hierarchical database description (DBD) 101 from an arbitrary Extensible Markup Language (XML) schema. The system 100 includes a processor 102, Input/Output (I/O) devices 104, an I/O controller 106, a memory 108, and a communication bus 110. Those of skill in the art recognize that the system 100 may be more simple or complex than illustrated so long as the system 100 includes modules or sub-systems that correspond to those described herein. In one embodiment, the system 100 comprises hardware and/or software more commonly referred to as an Information Management System (IMS) as provided by IBM of Armonk, N.Y. In other embodiments, the system may include hardware and/or software such as a personal computer, a mainframe, a Multiple Virtual Storage (MVS), OS/390, zSeries/Operating System (z/OS), UNIX, Linux, or Windows.

Typically, the processor 102 comprises one or more central processing units executing software and/or firmware to control and manage the other components within the system 100. The I/O devices 104 permit a user 112 to interface with the system 100 via the user interface (UI) 114. In one embodiment, the user 112 provides an XML schema 116 to the system 100 via the I/O devices 104. Alternatively, an XML schema 116 maybe provided through an application within the system 100 or from an application on another system. XML schemas 116 are the successors of Document Type Definitions (DTD) for XML and, like DTD, define the legal building blocks of an XML document. The I/O devices 104 may include standard devices such as a keyboard, monitor, mouse, and the like. The communication bus 110 is coupled to the communication I/O devices 104 via one or more I/O controllers 106 that manage data flow between the components of the system 100 and the I/O devices 104.

The communication bus 110 operatively couples the processor 102, memory 108, and I/O controllers 106. The communication bus 110 may implement a variety of communication protocols including Peripheral Communications Interface, Small Computer System Interface and the like.

The memory 108 may include a user interface (UI) 114 and a database description (DBD) utility 118. When a user 112 desires to generate a DBD from an arbitrary XML schema 116 the user may define the arbitrary XML schema 116 within the UI 114. Alternatively, the XML schema 116 may be provided through the I/O devices 104 as described above or, in other embodiments, may be provided through other means of electronic communication such as a storage disk, across a network, or other means recognized by one skilled in the relevant art.

In one embodiment, the UI 114 provides the XML schema 116 to the DBD utility 118. The DBD utility 118 completes the steps necessary to generate an IMS hierarchical database description 101 from the XML schema 116 as described herein. These steps may include but are not limited to: parsing an XML schema 116 comprising a single root element; generating an XML schema tree that corresponds to the XML schema 116; generating an IMS segment tree that corresponds in structure and order to the XML schema tree such that each XML schema node is represented by a corresponding IMS segment node; reducing the number of IMS segment nodes from the IMS segment tree based on reduction rules, such that the IMS segment tree corresponds to IMS hierarchical database constraints; and generating an IMS database description 101 corresponding to the reduced IMS segment tree.

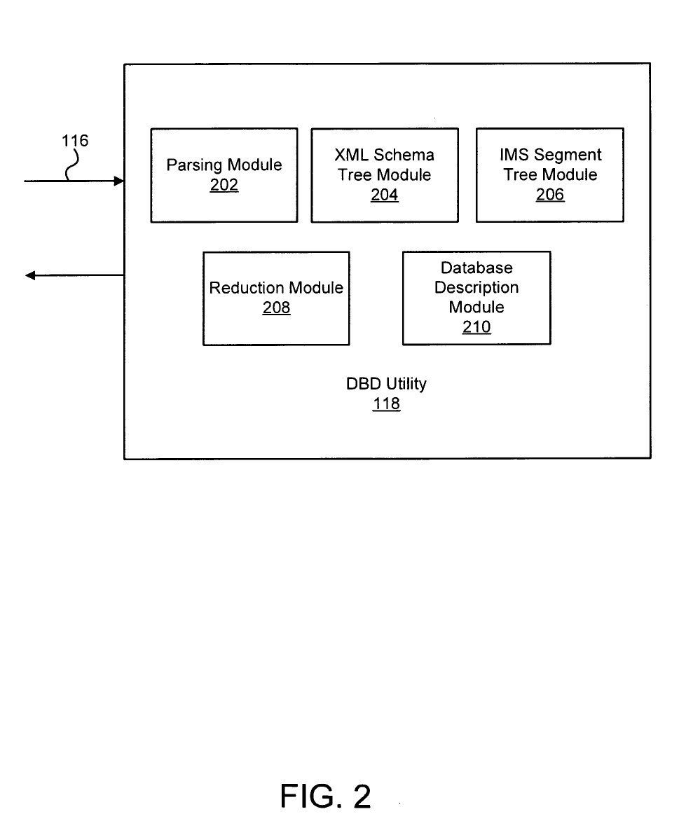

FIG. 2 is a schematic block diagram illustrating one embodiment of a DBD utility 118 for generating an IMS hierarchical database description 101 from an arbitrary XML schema 116. The DBD utility 118, in one embodiment, includes a parsing module 202, an XML schema tree module 204, an IMS segment tree module 206, a reduction module 208, and a database description module 210.

The parsing module 202 parses an XML schema 116 comprising a single root element. An XML schema 116 is itself an XML document. An XML document is made up of data units called entities, which contain either parsed or unparsed data. Prior to being inserted into an IMS database in accordance with the present invention all XML documents must be parsed, and all entities must be resolved. Parsed data is made up entirely of text, defined as a sequence of characters. In order to accurately round trip an XML document through an IMS database, enough information must be captured in order to completely reconstruct the original full text contained inside any given stored XML document. Because an XML schema 116 is also an XML document, it may be parsed along with any XML documents that are stored in a corresponding IMS database.

The XML schema tree module 204 generates an XML schema tree that corresponds to an XML schema 116. An XML schema tree is the hierarchical representation of the XML schema structure. A parsed XML schema made up entirely of text can be further broken down into a combination of markup and character data. Markup is the portion of text that describes the document's layout and logical structure. Markup may take the form of start-tags, end-tags, empty-element tags, entity references, character references, comments, CDATA section delimiters, document type declarations, processing instructions, XML declarations, text declarations, and any white space that is at the top level of an XML entity. Any text in an XML schema that is not defined as markup is considered character data. The separation in the XML data model between structure and content lends itself to the generation of a hierarchical XML schema tree where, for example, the XML entities make up the nodes of a tree descending from a single root element as described below.

The XML schema tree module 204 may also store the XML schema 116 such that metadata within the XML schema 116 that is redundant for each XML document valid with respect to the XML schema 116 is accessible to an IMS hierarchical database system to recreate the XML document using the stored XML schema 116 and the IMS database that corresponds to a given IMS database description. Therefore, information that is preserved within the persistent XML schema 116 need not be stored again in the IMS database.

The IMS segment tree module 206 generates an IMS segment tree that corresponds in structure and order to the XML schema tree such that each XML schema node is represented by a corresponding IMS segment node. Like the separation in the XML data model between structure and content, a similar separation exists in the IMS data model between structure and content. Therefore, the structure of an XML schema and its corresponding XML schema tree can be captured by the existence of corresponding IMS segment instances and the hierarchical relationships between them in an IMS segment tree. In one embodiment, the nodes of the XML schema tree map directly to the nodes comprising the IMS segment tree. Alternatively, multiple nodes on the XML schema tree may be represented by a single node on the IMS segment tree and vice versa.

Preferably, the XML documents stored in an IMS database defined by the hierarchical database definition 101 generated by the present invention comprise validated XML documents with respect to the XML schema 116. By aligning the document order defined in the XML schema 116 with the IMS database hierarchic order, the document order may be preserved such that an XML document generated from the IMS database description 101 retains the same XML document order. Document order is the order in which the components (ie: elements, attributes, etc.) of an XML document occur in the original document.

Typically, the IMS segment tree is generated by mapping XML schema particles to IMS segment definitions. For example, elements and attributes may be mapped to IMS segment definitions and simple data types may be mapped directly into IMS segment fields. In one embodiment, the resulting IMS segment tree may contain more levels and segments than is desirable, or are permitted by conventional IMS database systems, so the reduction module 208 may be executed to reduce the size of the IMS segment tree.

The reduction module 208 reduces the number of IMS segment nodes from the IMS segment tree based on reduction rules, such that the IMS segment tree corresponds to IMS hierarchical database constraints. The reduction of the IMS segment tree is possible because the XML schema 116 is stored and can be accessed during document reconstruction. This allows certain reduced IMS segment nodes to be recreated at run time based on relationships still existing in the persistent XML schema 116. The reduction module 208 may eliminate IMS segment nodes that correspond to XML schema tree nodes having a minOccurs value and a max Occurs value equal to zero. IMS segment leaf nodes that correspond to XML schema tree nodes defined by the XML schema to have a predetermined number of occurrences and no data fields may also be eliminated. IMS segments having corresponding XML schema nodes with fixed value simple data types may also be eliminated.

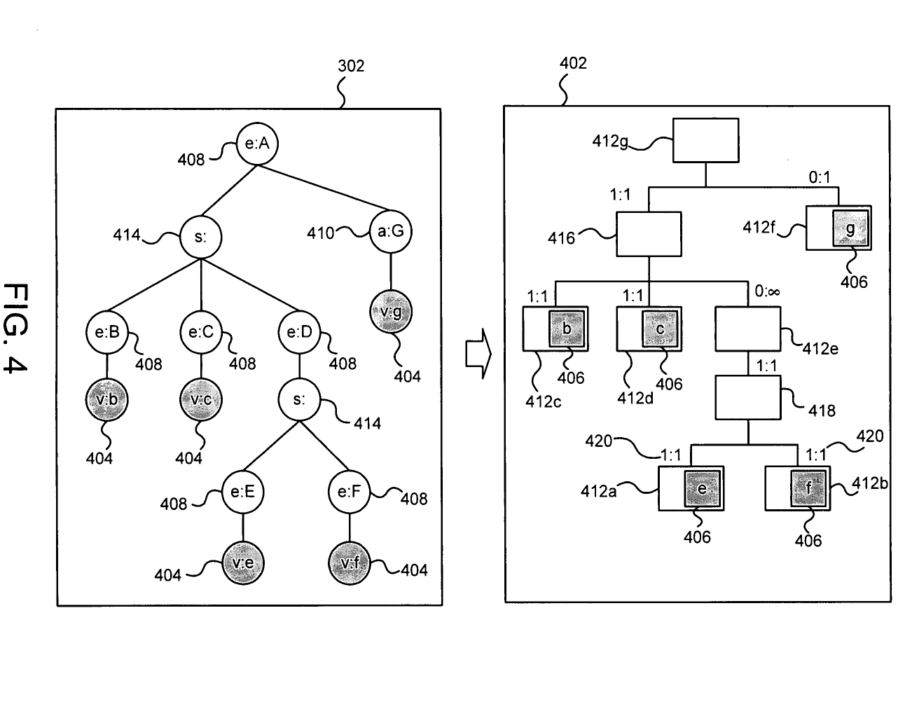

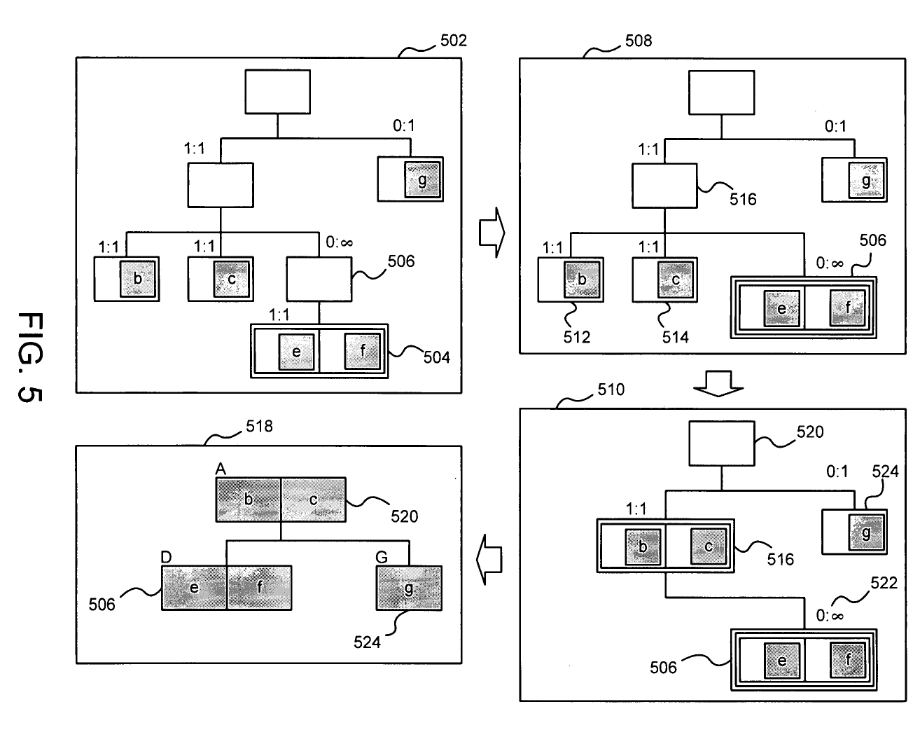

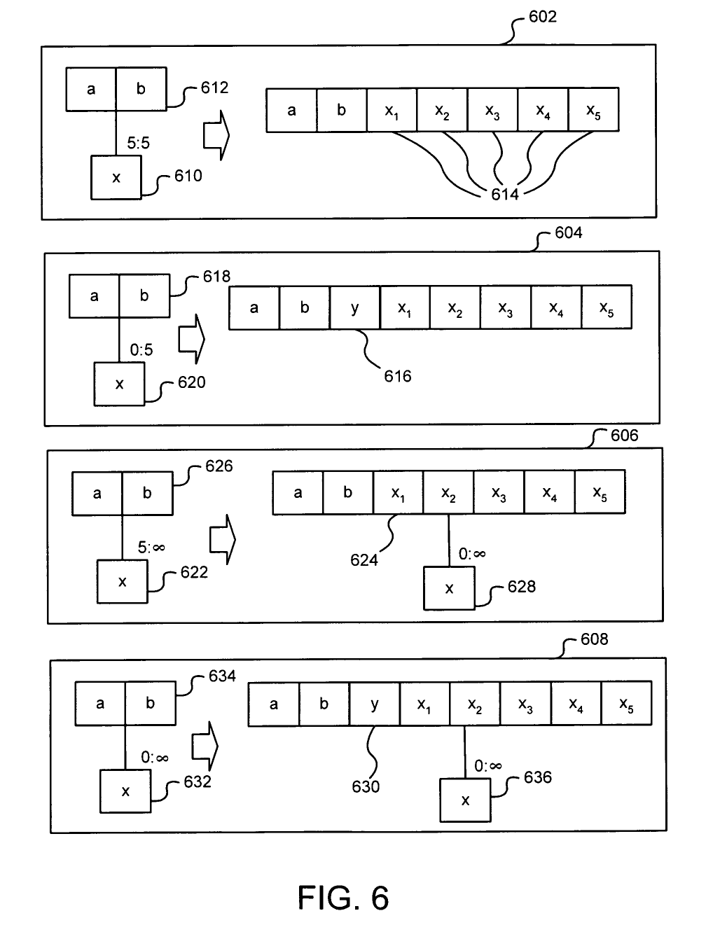

Additionally, the reduction module 208 may merge a child IMS segment with a parent IMS segment node in response to the child IMS segment node having a one-to-one relationship with the parent IMS segment node. Examples of these reduction steps are described below and depicted in FIGS. 4 and 5. IMS segment leaf nodes may also be merged into fields of a parent IMS segment node such that the child IMS segment order is preserved by the sequential ordering of the corresponding fields in the parent IMS segment as described below and depicted in FIG. 6. In one embodiment, the reduction module 208 may reduce the IMS segment tree such that the IMS database description 101 comprises less than 16 levels and less than 256 segments.

The database description module 210 generates an IMS database description (DBD) 101 corresponding to the reduced IMS segment tree. An IMS database description 101 defines the physical implementation of an IMS database. More particularly, the IMS database description 101 defines a preset static structure for the hierarchical data an IMS database may contain. The IMS database description 101 is data that enables IMS to build an IMS database having a specific structure and organization. Given the static nature of the IMS database structure, only data matching the structure predefined by the DBD 101 can appropriately be stored into an IMS database, therefore only XML documents matching the structure of an IMS database can be hierarchically stored therein.

Similarly, an XML schema 116 defines the allowed structure of an XML document. Only documents matching the defined structure are considered valid to that XML schema 116. By aligning the valid structure defined by an XML schema 116 with the allowed structure of an IMS database, a structurally aligned XML schema 116 both describes and validates the complete set of XML documents capable of being stored into, or retrieved from, a particular IMS database. Subsequently, a DBD 101 can be generated for describing such an IMS database. The DBD can then be used to implement a database capable of faithfully storing and retrieving XML documents valid to the XML schema 116. Because the XML schema tree module 204 stores the persistent XML schema 116 containing metadata that is redundant for each valid XML document, and because the reduction module 208 reduces the size of the hierarchy needed to store XML documents, the implemented database not only faithfully stores and retrieves XML documents valid to the XML schema 116, but does so by maintaining a much smaller hierarchical structure than is used by conventional systems.

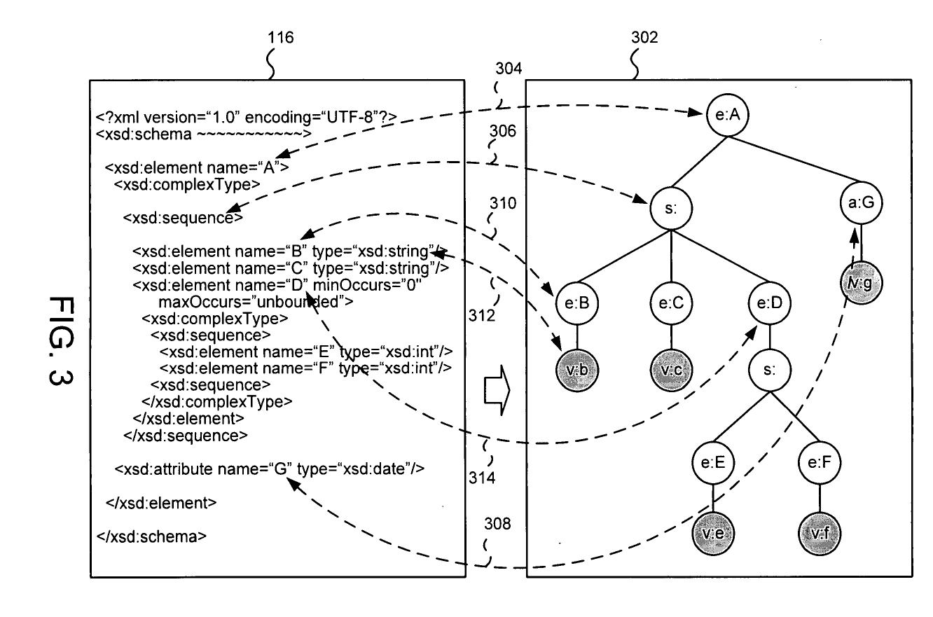

FIG. 3 is a schematic block diagram illustrating one embodiment of an XML schema 116 and its corresponding XML schema tree 302. The XML schema tree 302 is generated by the XML schema tree module 204. An XML schema 116 may include various components such as elements, model groups, wildcards, attributes or other XML schema components that are recognized by one skilled in the art. The XML schema tree module 204 generates the XML schema tree 302 from these components. Typically each component makes up a node on the XML schema tree 302. Because IMS databases are required to have a single root segment, the XML schema 116 preferably comprises a single root element. In this case, the element “A” 304 is the root element. The element “A” 304 is an element of complex type and maps to the top node of the XML schema tree 302 as depicted. The node label “e:A” in the XML schema tree 302 corresponds to the description “element name=A” 304 in the XML schema 116. Similarly, the node label “s:” in the XML schema tree 302 corresponds to the “sequence” component in the XML schema 116. Similar relationships exist between each of the components in the XML schema 116 and the corresponding XML schema tree 302.

The element “A” 304 has two child components a sequence 306 and an attribute “G” 308. The sequence 306 comprises several additional child elements including an element “B” 310, which is a simple data type “string” 312, as well as an element “D” 314. These components, including any simple data types, map to the XML schema tree 302 as descending nodes from their parent components as depicted. The XML schema tree module 204 continues to map each component of the XML schema 116 to a node in the XML tree 302 until all of the components in the XML schema 116 are represented by nodes in the XML schema tree 302. The resulting XML schema tree 302 is then used to generate a corresponding IMS segment tree.

FIG. 4 is a schematic block diagram illustrating one embodiment of an XML schema tree 302 and its corresponding IMS segment tree 402. The IMS segment tree module 206 generates the IMS segment tree 402 that corresponds in structure and order to the XML schema tree 302 such that each XML schema node is represented by a corresponding EMS segment node. The leaf nodes of the XML schema tree 302 are typically simple element or attribute definitions 404. These simple definitions 404 are either empty (marked only by their presence) or contain a simple data type. In XML documents, all character data is stored within the definitions of simple data types 404 which can subsequently be represented by the field types of IMS segments 406. Therefore, the IMS segment tree module 206 may map simple data types 404 directly into the IMS segment fields 406 of parent segments as depicted. The IMS segment fields 406 may include a corresponding label for the field or attribute such as “B”, “C”, “D”, “E”, “F”, or “G.” Simple data type definitions may include types such as string, int, date, or other type as will be recognized by one skilled in the art.

IMS databases represent multiplicity through the occurrence of multiple segment instances, and this multiplicity must be captured for both the element occurrences and the optional attribute occurrences from within the XML schema 116. For example, each element 408 or attribute 410 represented on the XML schema tree 302 is mapped to a corresponding segment definition 412a-g thereby preserving the multiplicity of the elements and attributes listed in the XML schema 116.

In order to successfully roundtrip an XML document by faithfully recreating the XML text, the document order of the original XML document must be preserved for certain document elements indicated in the corresponding XML schema. Document order is the order of the nodes in the XML document. Certain XML schema elements such as “<sequence>” impose a requirement that the data nodes in the XML document be listed in the same order as the elements of the sequence. In other words, document order is the order in which all elements, attributes, character data, etc. occur in the original document, such as an XML document. Preferably, the order requirement defined in the XML schema is honored when the data of the XML document is stored in the IMS database.

Typically, IMS utilizes a method of node ordering, referred to as hierarchic order. Hierarchic order is a depth first traversal of the nodes of the hierarchic structure of an IMS database. Therefore, in order to preserve document order for any stored XML document, the IMS segment tree module 206 aligns the XML document order defined in the XML schema 116 with the hierarchic order of the IMS database. Specifically, elements of the XML schema 116 that are nested within a “<sequence>” element are placed in the IMS segment tree 402 as child nodes in the order of the “<sequence>” and from left-to-right in the IMS segment tree 402.

In the example of FIG. 4, this means that the nodes of the XML schema 116 are mapped to the nodes of the IMS segment tree 402 such that the root node 304 of the XML schema 116 is eventually mapped to the root node 412g of the IMS segment tree 402. Then, the nodes 416 and 412f, corresponding to XML schema nodes 304 and 308, are mapped into the IMS segment tree 402, such that the nodes 416 and 412f descend from the root node 412f. Mapping continues in this manner until each of the XML schema nodes are represented in the IMS segment tree and their order is preserved hierarchically.

This does present an ordering issue, however, between nodes on the same level of the IMS segment tree such as segment nodes 412a and 412b. Nodes on the same level of the IMS segment tree 402 sharing a parent are typically referred to as twins if they are the same segment type, and siblings if they have different segment types.

IMS orders the segments within the database, such as twins and siblings, based on either an insertion order parameter or the existence of a key sequential field. If a segment has a field labeled as its sequential key, all twins will be ordered sequentially based on that key, independent of the order they were inserted in. In some situations, this keying aspect can make XML document order alignment with the IMS hierarchic order unpredictable. Therefore, when generating an IMS segment tree 402 from an XML schema tree 302, the IMS segment tree module 206 preferably ensures that segment definitions corresponding to XML schema components remain un-keyed such that document order among segment twins is preserved based on an insertion order parameter. Therefore, the order in which twins and siblings are inserted will be preserved within the IMS database thereby allowing the document order of twins and siblings to also be preserved.

In situations where document order among twins is not required, sequential keying may still be used as will be recognized by one skilled in the art. In one embodiment, the IMS segment tree module 206 ensures that document order among twins is preserved by requiring insertion parameter based ordering. In another embodiment, a database administrator decides when document ordering among element twins must be preserved, and when document ordering can be sacrificed for performance or other gains.

Similar to twin reordering, under certain circumstances, IMS may inadvertently group together sibling elements from the XML schema 116 and lose document order among corresponding sibling segments. This can happen as a result of the use of model groups.

A model group is a constraint in the form of a grammar fragment that applies to lists of element information items. These element information items take the form of elements, wildcards, and further model groups such as sequence, all, and choice as will be recognized by one skilled in the art. To retain the distinction of multiple occurrences of model groups, to distinguish individual model group instances, and to preserve sibling document ordering, the IMS segment tree module 206 maps model groups to empty segment definitions. For example, sequence 306 in the XML schema 116 is eventually mapped to empty segment 416 in the IMS segment tree 402.

Generally then, the IMS segment tree 402 is generated by mapping XML schema particles to IMS segment definitions. XML schema particles may include: elements 408; attributes 410; wildcards; and model groups such as sequence 414, all, and choice. The resultant IMS segment tree 402 may be impractical where every segment includes either exactly one field or may be completely empty. Additionally, the IMS segment tree 402 may not comply with IMS database size constraints so a reduction of the IMS segment tree 402 may be needed. IMS database size constraints may include a maximum number of allowable levels and/or a maximum number of allowable nodes.

FIG. 5 is a schematic block diagram illustrating one embodiment of the reduction of an IMS segment tree 402. In one embodiment, reduction takes place concurrently with the generation of the IMS segment tree 402, or in another embodiment, reduction may take place after the IMS segment tree 402 has been completely generated. The reduction module 208 may eliminate fields or segments that are not needed to recreate a stored XML document while still preserving validity and document order. This is possible because a persistent XML schema 116 is stored and may be referenced during document recreation. Therefore, information not needed to preserve validity and document order does not need to be stored in the database, because it is already stored within the XML schema 116. For example, when a particle has a minOccurs and maxOccurs clause set to zero, this means that no valid document may have any occurrences of that particular segment. Therefore, the associated particle does not need to be represented, and the corresponding segment can be eliminated provided XML documents stored in the IMS database are valid with respect to the XML schema 116.

One-to-one segment reduction occurs whenever a particle has a minOccurs and maxOccurs of one. In this situation, a segment occurrence will always exist in a one-to-one relationship with its parent. In such a case, the entire segment can be moved up and included as a field in the parent segment. For example, referring back to FIG. 4, segments 412a and 412b have a minOccurs 420 and a maxOccurs 420 that are both equal to one.

Referring now to FIG. 5, reduced segment tree 502 illustrates the results of applying one-to-one segment reduction to the IMS segment tree 402. Segments 412a-b are shown merged into the fields of the parent segment 504. Parent segment 504 is also in a one-to-one relationship with its parent segment 506. Reduced segment tree 508 illustrates the results of applying one-to-one segment reduction to the reduced segment tree 502. Segment 504 is merged into the fields of segment 506.

Likewise, in reduced segment tree 510, reduction module 208 merges segments 512 and 514, which also have a one-to-one relationship with their parent segment 516, into the fields of that parent segment 516. Finally, reduced segment tree 518 shows segment 516 merged with segment 520 illustrating the significant reduction of the IMS segment tree 402. The IMS segment tree 402 has been reduced from four levels to two. Segment 506 cannot be merged with segment 520 because, as defined in the XML schema 116, segment 506 has a minOccurs equal to zero and a maxOccurs equal to infinity 522 which is not a one-to-one relationship with the parent segment 520.

Additionally, attributes have a fixed requirement that maxOccurs is equal to one so segment 524 which was generated from an attribute in the XML schema 116 also cannot be merged with segment 520. A reduced segment must still re-create the eliminated parent child relationship during retrieval from the IMS database, based on the relationship still existing in the persistent XML schema 116. In one embodiment, the XML schema 116 is stored in the IMS database to be referenced at runtime.

Another type of reduction occurs when the XML schema 116 requires simple data types to have a particular value. If each occurrence of a particular field in an IMS data base is required to have the same value, and that value is known for the entire database, there is no benefit in actually storing that data in the database. Therefore, the segment field that holds the fixed value can be eliminated because the data is preserved through XML schema validation, although the segment itself may not necessarily be eliminated. The eliminated fixed value is recreated at runtime during data retrieval from the IMS database, based on the fixed value existing in the persistent XML schema 116.

The IMS segment tree 402 may also be reduced when a segment has neither data nor children and the exact number of instances is known. This situation may arise if the minOccurs and maxOccurs clauses are equal, or the number of occurrences is stored in the parent segment. Four such situations are depicted in FIG. 6.

FIG. 6 is a schematic block diagram illustrating embodiments that incorporate four reduction rules for merging child IMS segments with parent IMS segments. These types of reduction rules are known herein as leaf segment unrolling. Similar to moving the contents of a segment into its parent segment when a one-to-one relationship is defined, leaf segment unrolling comprises combining possibly repeating contents of one or more child segments with the parent segment by sequentially ordering the contents of the child segments as fields in the parent segment. The reduction module 208 may perform fixed unrolling 602, variable unrolling 604, fixed unbounded unrolling 606, and variable unbounded unrolling 608 to further reduce the IMS segment tree 402.

Fixed unrolling 602 is possible when the exact required multiplicity of a field or group of fields in a child segment 610 is known. For example, child segment 610 has a minOccurs equal to five and a maxOccurs equal to five. Because each valid XML document will satisfy the corresponding XML schema 116, there will be exactly five occurrences of that child segment 610. Those occurrences can be merged with the parent segment 612 by including the child segments 610 as five sequential fields 614 in the parent segment 612 as depicted.

Variable unrolling 604 is similar to fixed unrolling 602 but adds a transparent count field 616. Like fixed unrolling, a predefined number of fields are unrolled into the parent segment definition 618. The count field 616 determines on a per segment basis how many occurrences of the now unrolled segment 620 exist in that parent occurrence. During document retrieval, each unrolled segment less than or equal to the count is treated as an existing occurrence, and used to populate the retrieved or examined XML document. This situation typically occurs where there may exist a variable number of child segments 620 such as for example when minOccurs equals zero and maxOccurs equals five.

Fixed unbounded unrolling 606 may occur when there are a fixed minimum number of child segments, but an unbounded maximum number of child segments. For example, child segment 622 has a minOccurs equal to five and a maxOccurs equal to infinity. In this situation, the five defined child segments 624 are merged into the parent segment 626 and the unbounded variable number of remaining child segments 628 are left as child segments 628. In one embodiment, the child segments 628 may comprise one or more separate child segments.

Variable unbounded unrolling 608 may be used when minOccurs equals zero and maxOccurs is unbounded. In this situation, like variable unrolling 604, a count 630 is used to define the number of child segments 632 that are merged into the parent segment 634. The remaining child segments 636 are implemented as child segments 636.

Any combination of the reduction rules described above may be used to reduce the IMS segment tree 402. It is not a requirement to use all of the reduction rules, and there may be other reduction rules that are not listed here. In some circumstances, the reduction rules may not be implemented at all and a DBD may be generated directly from the IMS segment tree 402.

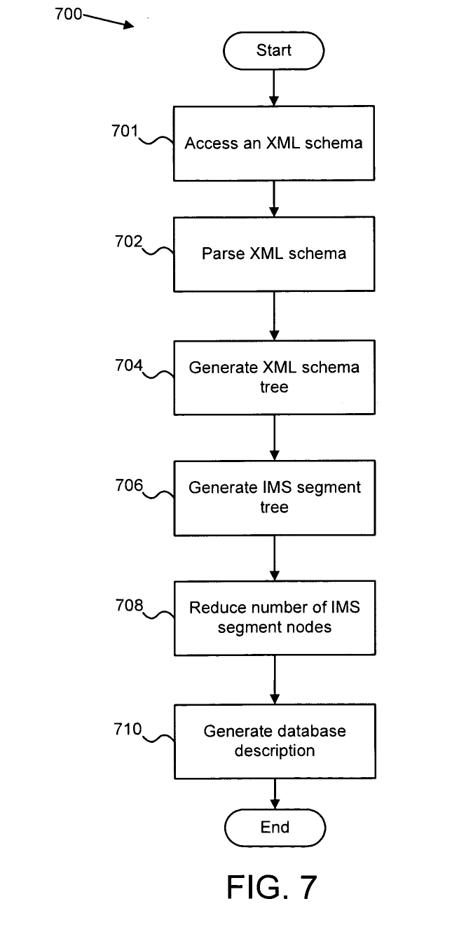

FIG. 7 is a schematic flow chart diagram illustrating one embodiment of a method 700 for automatically generating an IMS hierarchical database description 101 from an arbitrary XML schema 116 in accordance with the present invention. The method 700 starts and an XML schema 116 is accessed 701. The XML schema 116 may be input by a user 112, stored in memory 108, accessed across a network, through an application or any other means recognized by one skilled in the art. The parsing module 202 parses 702 the XML schema 116 comprising a single root element in order to identify the entities. The XML schema tree module 204 generates 704 an XML schema tree 302 that corresponds to the parsed XML schema 116.

The XML schema tree module 204 may also store the XML schema 116 such that metadata within the XML schema 116 that is redundant for each XML document valid with respect to the XML schema 116 is accessible to an IMS hierarchical database system to recreate the XML document using the stored XML schema 116 and the IMS database that corresponds to a given IMS database description. Therefore, information that is preserved within the persistent XML schema 116 need not be stored again in the IMS database. Next, The IMS segment tree module 206 generates 706 an IMS segment tree 402 that corresponds in structure and order to the XML schema tree 302 such that each XML schema node is represented by a corresponding IMS segment node. The character data from an XML document that will be stored in the resulting IMS database is represented by data stored within the fields of the IMS segments that comprise the IMS segment tree 402. Typically, the XML documents comprise validated XML documents with respect to the XML schema 116. Document order may be preserved by aligning the XML document order of the XML schema 116 with IMS database hierarchic order such that an XML document generated from the IMS database description 101 retains the same XML document order. The IMS segment tree 402 is typically generated by mapping XML schema particles to IMS segment definitions as described above.

The reduction module 208, as described above, reduces 708 the number of IMS segment nodes from the IMS segment tree 402 based on reduction rules, such that the IMS segment tree 402 corresponds to IMS hierarchical database constraints. In one embodiment, the IMS hierarchical database constraints include limiting the IMS database to less than 16 levels and less than 256 segments.

The database description module 210 generates 710 a database description 101 corresponding to the reduced IMS segment tree. An IMS database description 101 defines the physical implementation of an IMS database. More particularly, it defines a preset static structure for the hierarchical data an IMS database may contain. Given the static nature of the IMS database structure, only data matching the structure predefined by the DBD can appropriately be stored into the resulting IMS database, therefore XML documents matching the structure of the IMS database can be hierarchically stored therein. The database description 101 generated 710 by the method 700 allows for XML documents valid to the XML schema 116 to be stored, indexed and retrieved from an IMS hierarchical database generated by the database description 101. Because the XML schema tree module 204 stores the persistent XML schema 116 containing metadata that is redundant for each valid XML document, and because the reduction module 208 reduces the size of the hierarchy needed to store XML documents, the generated database not only faithfully stores and retrieves XML documents valid to the XML schema 116, but does so by maintaining a much smaller hierarchical structure than is used by conventional systems.

In one embodiment of the method 700, the parsing module 202, the XML schema tree module 204, the IMS segment tree module 206, the reduction module 208, and the database description module 210 may be contained within a DBD utility 118 that is executable by customers. The method 700 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A programmed method for automatically generating an information management: System (IMS) hierarchical database description from an arbitrary Extensible Markup Language (XML) schema, the programmed method comprising the process steps of:
parsing an XML schema comprising a single root element;
generating an XML schema tree that corresponds to the XML schema;
generating an IMS segment tree that corresponds in structure and order to the XML schema tree such that each XML schema node is represented by a corresponding IMS segment node; and
generating an IMS database description corresponding to the IMS segment tree.

2. The programmed method of claim 1, wherein the programmed method is in the form of process steps.

3. The programmed method of claim 1, the programmed method is in the form of a computer readable medium embodying computer instructions for performing the process steps.

4. The programmed method of claim 1, wherein the programmed method is in the form of a computer system programmed by software, hardware, firmware, or any combination thereof, for performing the process steps.

5. The programmed method of claim 1, wherein the programmed method is in the form of an apparatus comprising software, hardware, firmware, or any combination thereof, for performing the process steps.

6. The programmed method of claim 1, further comprising the process step of reducing the number of IMS segment nodes from the IMS segment tree based on reduction rules, such that the IMS segment tree complies with IMS hierarchical database constraints.

7. The programmed method of claim 1, further comprising eliminating IMS segment nodes that correspond to XML schema tree nodes having a minOccurs value and a maxOccurs value equal to zero.

8. The programmed method of claim 1, further comprising storing the XML schema such that metadata within the XML schema that is redundant for each XML document valid with respect to the XML schema is accessible to an IMS hierarchical database system to recreate the XML document using the stored XML schema and the IMS database that corresponds to the IMS database description.

9. The programmed method of claim 1, further comprising eliminating IMS segment leaf nodes that correspond to XML schema nodes defined by the XML schema to have a predetermined number of occurrences and no data fields.

10. The programmed method of claim 1, further comprising merging a child IMS segment with a parent IMS segment node in response to the child IMS segment node having a one-to-one relationship with the parent IMS segment node.

11. The programmed method of claim 1, further comprising eliminating fields from IMS segments having corresponding XML schema nodes with fixed value simple data types.

12. The programmed method of claim 1, further comprising merging one or more IMS segment leaf nodes into fields of a parent IMS segment node such that the child IMS segment order is preserved by the sequential ordering of the corresponding fields in the parent IMS segment.

13. The programmed method of claim 1, wherein the character data from an XML document is represented by data stored within the fields of the IMS segments that comprise the IMS segment tree, the XML document comprising a validated XML document with respect to the XML schema.

14. The programmed method of claim 1, wherein the process step of generating an IMS segment tree corresponding to the XML schema tree further comprises preserving document order by aligning XML document order of the XML schema with IMS database hierarchic order such that an XML document generated from the IMS database description retains the same XML document order.

15. The programmed method of claim 1, wherein the process step of generating an IMS segment tree corresponding to the XML schema tree further comprises mapping XML schema particles to IMS segment definitions.

16. The programmed method of claim 1, wherein the IMS database description comprises less than 16 levels and less than 256 segments.

17. A system to automatically generate an IMS hierarchical database description from an arbitrary XML schema, the system comprising:
one or more processors;
a memory;
Input/Output (I/O) devices configured to interact with a user;
an IMS database; and
an IMS database description utility comprising a plurality of modules, the modules configured to:
parse an XML schema comprising a single root element;
generate an XML schema tree that corresponds to the XML schema;
generate an IMS segment tree that corresponds in structure and order to the XML schema tree such that each XML schema node is represented by a corresponding IMS segment node;
reducing the number of IMS segment nodes from the IMS segment tree based on reduction rules, such that the IMS segment tree corresponds to IMS hierarchical database constraints; and
generate an IMS database description corresponding to the reduced IMS segment tree.

18. The system of claim 17, wherein the database description utility further comprises a module configured to eliminate IMS segment nodes that correspond to XML schema tree nodes having a minOccurs value and a maxOccurs value equal to zero.

19. The system of claim 17, wherein the database description utility further comprises a module configured to eliminate IMS segment leaf nodes that correspond to XML schema nodes defined by the XML schema to have a predetermined number of occurrences and no data fields.

20. The system of claim 17, wherein the database description utility further comprises a module configured to merge a child IMS segment with a parent IMS segment node in response to the child IMS segment node having a one-to-one relationship with the parent IMS segment node

21. A method for automatically generating an IMS hierarchical database description from an arbitrary XML schema, the method comprising:
accessing an XML schema;
executing an IMS database description utility comprising a plurality of modules, the modules configured to:
parse the XML schema;
generate an XML schema tree that corresponds to the XML schema;
generate an IMS segment tree that corresponds to the XML schema tree;
reduce the number of IMS segment nodes from the IMS segment tree based on reduction rules, such that the IMS segment tree corresponds to IMS hierarchical database constraints; and
generate an IMS database description corresponding to the reduced IMS segment tree.
